(19) United States
(12) Patent Application Publication
(10) Pub. No.: US 2025/0086880 A1
(43) Pub. Date: Mar. 13, 2025

(54) SYSTEMS AND METHODS FOR VIRTUAL ARENA EXPERIENCES

(71) Applicant: Gilad Eliezer Tsur Mayer, Kefar Sava (IL)

(72) Inventor: Gilad Eliezer Tsur Mayer, Kefar Sava (IL)

(21) Appl. No.: 18/883,229

(22) Filed: Sep. 12, 2024

Related U.S. Application Data
(60) Provisional application No. 63/537,841, filed on Sep. 12, 2023.

(51) Int. Cl. G06T 15/20; A63F 13/52

(52) U.S. Cl. CPC G06T 15/20; A63F 13/52

(57) ABSTRACT

An adverse media screening system for providing virtual arena experiences and delivering interactive, and immersive virtual experiences to spectators may utilize one or more computing devices equipped with processors to determine an avatar associated with a spectator of a virtual event. A point-of-view of the avatar may be determined. A rendering of the virtual arena may be determined based on the point-of-view of the avatar and the rendering of the virtual arena may be transmitted to a device associated with the spectator of the virtual event.

### CROSS-REFERENCE TO RELATED APPLICATIONS

This patent application claims the benefit of, and priority to, U.S. Provisional Patent Application No. 63/537,841, filed Sep. 12, 2023, and entitled “METHOD FOR ORGANIZING VIDEO GAME AMERICAN FOOTBALL TOURNAMENTS,” the contents of which are incorporated by reference in its entirety as if set forth herein.

### TECHNICAL FIELD

The present disclosure generally relates to systems and methods for providing virtual arena experiences and, more particularly, to delivering interactive and immersive virtual experiences to spectators.

### BACKGROUND

Video gaming has become a popular form of entertainment, with millions of gamers worldwide enjoying both playing and spectating video games. The advent of eSports and live streaming platforms has transformed gaming into a spectator sport, where fans can watch professional gamers and their favorite content creators (e.g., in real-time). Gamers not only seek immersive and engaging experiences while playing but also desire interactive and dynamic spectating experiences. However, conventional systems limit the extent to which spectators can engage with the virtual environment and other spectators.

One major technical problem in the realm of virtual event spectating is the lack of personalized and immersive experiences that mirror physical attendance. Conventional systems often provide a static viewing experience, where spectators have limited control over their viewpoint and interaction with the virtual environment. Spectators typically watch pre-determined camera angles or static streams, which do not allow for a personalized or interactive experience. This limitation reduces the engagement and immersion that spectators seek when watching virtual events.

Additionally, conventional systems fail to provide real-time, high-fidelity renderings of virtual environments that are customized based on individual spectator preferences and device capabilities. The diverse range of devices used by spectators, from high-end gaming consoles to mobile phones, presents a significant challenge in delivering consistent performance and visual quality. Conventional systems also do not effectively address the varying hardware capabilities and network conditions, resulting in suboptimal user experiences.

Moreover, conventional systems fail to enable interactions among spectators within the virtual arena, including realistic engagement with interactive elements and other spectators. This lack of interactivity limits the social and collaborative aspects of the spectating experience, which are crucial for maintaining engagement and interest.

Accordingly, there is an unresolved need for systems and methods for enhancing virtual event spectating, thereby meeting the growing demand for engaging and dynamic virtual experiences.

This background information is provided to reveal information believed by the applicant to be of possible relevance. No admission is necessarily intended, nor should be construed, that any of the preceding information constitutes prior art.

### SUMMARY

Briefly described, and in various aspects, the present disclosure generally relates to interactive virtual environments, particularly providing virtual arena experiences. Moreover, the present may address challenges associated with delivering real-time, immersive, and/or interactive virtual event spectating experiences.

The disclosed systems, methods, and computing devices may determine an avatar associated with a spectator of a virtual event. A point-of-view (POV) of the avatar may be determined within a virtual arena (e.g., based on a location of the avatar within the virtual arena). Spectators may customize their avatars, interact with other spectators' avatars through text, audio, and video communication, and/or engage with interactive elements within the virtual arena. According to some aspects, closed groups may be formed for private interactions.

The virtual arena may be rendered from the avatar's perspective and the rendering may be transmitted to a device associated with the spectator. For example, the virtual arena may be accessed through a variety of devices, including one or more of augmented reality (AR) and virtual reality (VR) devices, mobile phones, personal computers, or gaming consoles. The virtual arena may digitally represent a physical stadium and may host various types of virtual events, including music concerts, sports events, and comedy shows. Each of the virtual events may be characterized by a pre-determined schedule, e.g., a set time or date. The virtual arena may include multiple sections (e.g., dedicated to different activities or themes). Moreover, rendering of the virtual arena may be optimized by dynamically adjusting the level of detail based on the spectator's device capabilities.

According to some aspects, the disclosed systems, methods, and computing devices may allow for the purchase of virtual goods, the display of advertisements based on user preferences, and/or real-time updates and notifications associated with the virtual event. Furthermore, the disclosed systems, methods, and computing devices may record and replay interactions and events, integrate social media features, and/or implement security measures to ensure safe and secure interactions.

Aspects of the disclosure may address the need for enhanced virtual event spectating experiences by providing a scalable, efficient, and secure solution that delivers high-fidelity, personalized, and interactive virtual environments. By applying advanced computing techniques, such as distributed computing, machine learning algorithms, spatial audio processing, and/or advanced compression techniques, spectators may enjoy a seamless and engaging experience across different hardware and network conditions.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE FIGURES

Reference will now be made to the accompanying drawings, which are not necessarily drawn to scale.

FIG. 1 illustrates an example gaming environment, according to various aspects of the present disclosure;

FIG. 2 illustrates an example networked environment, according to various aspects of the present disclosure;

FIG. 3 illustrates an example user interface corresponding to a portion of the functionality implemented by portions of the gaming environment, according to various aspects of the present disclosure;

FIG. 4 illustrates an example flowchart of certain functionality implemented by portions of the gaming environment, according to various aspects of the present disclosure;

FIG. 5 illustrates a schematic of an exemplary device, according to various aspects of the present disclosure; and

FIG. 6 illustrates an exemplary diagrammatic representation of a machine in the form of a computer system, according to various aspects of the present disclosure.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

For the purpose of promoting an understanding of the principles of the present disclosure, reference will now be made to the examples illustrated in the drawings and specific language will be used to describe the same. It will, nevertheless, be understood that no limitation of the scope of the disclosure is thereby intended; any alterations and further modifications of the described or illustrated examples and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

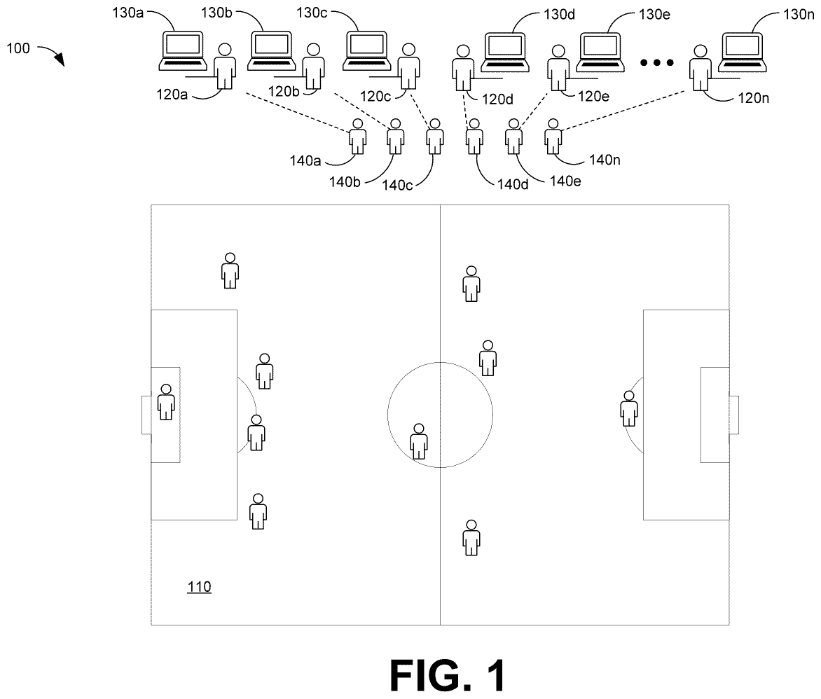

Referring now to the figures, for the purposes of example and explanation of the fundamental processes and components of the disclosed systems and processes, reference is made to FIG. 1, which illustrates an example, high-level overview of a virtual environment 100. As will be understood and appreciated, the example, high-level overview of the virtual environment 100 shown in FIG. 1 represents merely one approach or example of the present system, and other aspects are used according to various examples of the present system.

The virtual environment 100 may include a rendered virtual event 110 (e.g., a virtual soccer game taking place on a soccer field). One or more spectator avatars 140 may spectate the virtual event 110 in the virtual environment 100. The spectator avatars 140 may interact in the virtual environment 100 to spectate the event taking place in the virtual environment 100. A POV of each of the spectator avatars 140 may be determined within the virtual environment 100 (e.g., based on a location of the respective spectator avatar 140 within the virtual environment 100). Spectator avatars 140 may interact with other spectator avatars 140 through text, audio, and video communication, and/or engage with interactive elements within the virtual environment 100.

The virtual environment 100 may be accessed through various types of spectator computing devices 130, including augmented reality (AR) devices, virtual reality (VR) devices, mobile devices, personal computers, and gaming consoles. This multi-platform compatibility may allow spectators 120 to participate in the virtual event 110 based on their device individual device preferences and/or technical capabilities associated with the spectator computing devices 130. For example, a spectator 120 using a VR headset may experience a fully immersive 3D environment, while another spectator 120 on a mobile device may access a more streamlined version of the virtual event 110, optimized for their device's processing power and screen size.

According to some aspects, the virtual environment 100 may comprise a dynamic rendering engine that optimizes the visual experience based on one or more capabilities associated with the spectator computing devices 130. The virtual environment 100 may dynamically adjust a level of detail in a rendering of the virtual event 110 to ensure a smooth and high-quality viewing experience across different spectator computing devices 130. For example, a high-end gaming console may render the virtual event 110 with maximum detail and realistic lighting effects, while a mobile device may display a simplified version with reduced graphical intensity to maintain performance. Moreover, the virtual environment 100 may support synchronization mechanisms to ensure that all spectators 120 experience the virtual event 110 concurrently (e.g., in real-time or delayed), regardless of their geographical location or device. By minimizing latency and handling high volumes of data transmission efficiently, the immersive experience may be maintained and all interactions, such as live chats and in-game polls, may be kept consistent across all spectators 120.

The virtual environment 100 may include a plurality of security measures (e.g., end-to-end encryption) to protect communications and interactions within the virtual environment 100. The security measures may ensure that personal data, payment information, and/or in-event activities are securely transmitted and stored. Redundancy and failover mechanisms may maintain continuous availability of the virtual event 110, even in the event of hardware or network failures. The redundancy and failover mechanisms may allow spectators 120 to enjoy an uninterrupted virtual experience. For example, the virtual environment 100 may automatically switch to backup servers or alternative network routes as needed to prevent service disruptions.

Each of the spectator avatars 140 may be customized (e.g., to represent users associated with each of the respective spectator avatars 140) to allow spectators 120 to personalize their digital representation within the virtual environment 100. Spectators 120 may select from a range of customization options, including clothing, accessories, and/or physical attributes. Customization options may be expanded through the purchase of virtual goods, which may be acquired via a payment system integrated into the virtual environment 100. Virtual goods may include exclusive items, such as team jerseys, celebratory animations, or unique avatar accessories, enhancing the spectator's engagement and allowing for greater personalization.

Though discussed in the context of a virtual soccer field and the sport of soccer, the virtual environment 100 may include any event or particular sporting game. For example, the virtual environment 100 may include a virtual baseball field, a virtual American football field, and/or a virtual basketball court for playing each of the associated sports. Moreover, the virtual environment 100 may include a virtual venue for an event, such as a concert, a conference, a political rally, etc. Furthermore, the event may include, for example, a sports competition, a music concert, a theatrical performance, a conference, a political rally, a virtual meet-and-greet, a product launch, a movie screening, a virtual reality tour, an eSports tournament, a multiplayer gaming session, or any other type of live, pre-recorded, virtual, or gaming-related gathering or presentation.

The virtual event 110 may be characterized by a pre-determined schedule, e.g., set to occur at a specific time and date. For example, the time and date may provide awareness for all participants, spectators, and/or systems of the moment when the virtual event 110 will begin. By setting the virtual event 110 on a pre-determined schedule, the virtual or real-time interactions may be properly synchronized, thereby avoiding any potential conflicts in participation. Moreover, one or more virtual elements, such as avatar participation or automated functions, may be seamlessly integrated to align with the planned time of the event. Additionally, the pre-determined schedule may facilitate coordination of external systems, such as broadcasting or other linked virtual activities, which may be triggered based on the set date and time.

According to some aspects, user inputs (e.g. gamepad inputs) associated with one or more players or spectators may be replicated. The replication may be performed with high fidelity, for example, capturing one or more of the timing, sequence, and/or pressure applied to various controls on a gamepad. By replicating the inputs, the virtual event (e.g., as experienced by spectators) may closely mirror the actual gameplay and provide a detailed and accurate representation of the actions taken by the players and spectators. This high-fidelity replication may allow spectators to observe the intricacies of gameplay, including subtle maneuvers and strategies employed by the players, thereby enhancing the overall viewing experience.

Moreover, a representation of real event actions may be simulated, where the simulated representation is not an exact replica but rather an interpreted or abstracted version of a virtual event (e.g., gameplay). The simulated representation may be generated by simplifying or stylizing the actions based on predefined criteria, such as emphasizing key moments or general gameplay flow. The simulated output may present a more accessible or visually appealing rendition of the event, which may be particularly useful for spectators who prefer a more general overview rather than detailed gameplay. The simulated representation may also be utilized in scenarios where computational resources are limited, ensuring that the event remains engaging and comprehensible even on lower-end devices.

The virtual environment 100 may include one or more spectator computing devices 130. The spectator computing devices 130 may include mobile devices, personal computers, gaming systems, virtual reality systems, and/or any other suitable computing device. The spectator computing devices 130 may function as control systems for managing the spectator avatars 140. For example, the virtual environment 100 may render a virtual soccer field and virtual soccer players. The spectator avatars 140 may be rendered in the virtual environment 100, e.g., in a spectator section of the virtual environment 100. The spectator computing devices 130 may generate various commands to control the spectator avatars 140 and may perform the objectives of spectating the virtual event 110.

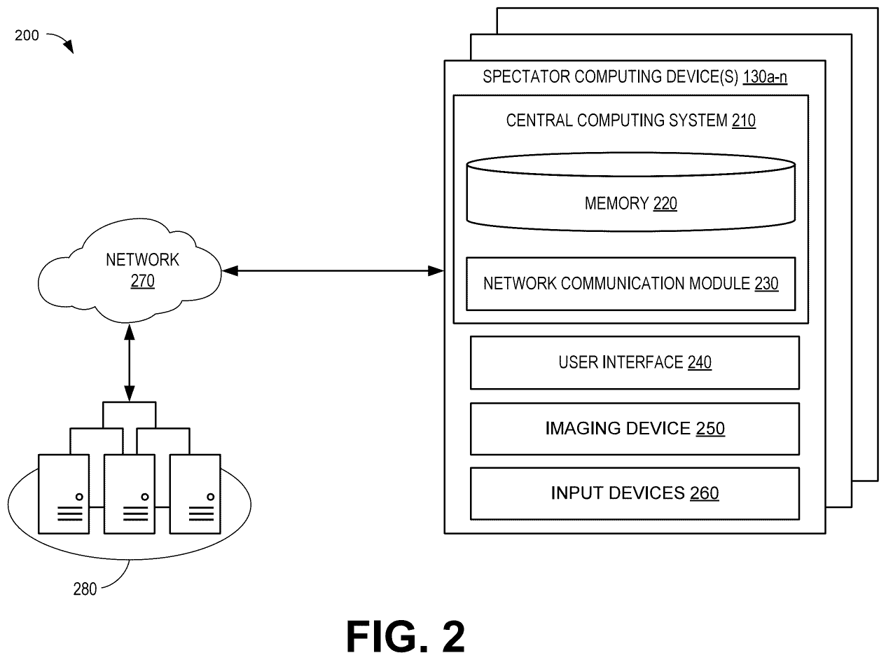

The spectator computing devices 130 may include one or more input devices 260 (e.g., as illustrated in FIG. 2) to receive commands from one or more spectators 120. The spectators 120 may operate the spectator computing devices 130 through the input devices 260 and use the inputs to control the spectator avatars 140. For example, the spectator 120 may interact with a video game controller functioning as the input device 211 of the spectator computing device 130. Continuing this example, the video game controller may send commands to the spectator computing device 130 to control the spectator avatar 140 in the virtual environment 100.

The virtual environment 100 can include one or more spectator avatars 140. The spectator avatars 140 can be three-dimensional renderings of human players. For example, the virtual environment 100 can generate the spectator avatars 140 based on a three-dimensional (also referred to herein as 3D) scan of the spectators 120, an image of each of the spectators 120, and/or any other input data associated with each spectator 120. The spectator avatars 140 may engage in a digital representation of a group of spectators. For example, the virtual environment 100 can include 22 spectator avatars 140, where each spectator avatar 140 is controlled by a particular spectator 120 through the spectator computing device 130. Continuing this example, the virtual environment 100 way render a soccer game, where spectator avatars 140 may be grouped in a spectator section.

Each spectator 120 may control one spectator avatar 140 such that there is a one-to-one mapping between spectators 120 and their digitally represented spectator avatars 140. Some spectator avatars 140 may be controlled automatically by a computing device without user input through the input devices 260. For example, if spectators 120 are engaging in a digital representation of spectating a soccer game, one spectator 120a may control a spectator avatar 140a corresponding to a first spectator of the virtual event 110, and another spectator 120b may control a spectator avatar 140b corresponding to a second spectator of the virtual event 110, and a computing device may control a spectator avatar 140c corresponding to a third spectator of the virtual event 110.

In some aspects, one or more spectator avatars 140 may be autonomously controlled by the system, e.g., rather than by spectators 120. The autonomously controlled avatars may be enhance the realism and/or density of the virtual crowd, providing a more dynamic and engaging environment for spectators 120. Behavior of the autonomously controlled avatars may be based on mimicking natural spectator interactions, such as cheering, reacting to in-game events, and/or engaging in simulated conversations. Moreover, automated control of one or more spectator avatars 140 may provide a seamless integration of avatars into the virtual arena, ensuring that the overall experience remains lively and immersive, even in scenarios where the number of human-controlled spectator avatars 140 is limited.

The virtual environment 100 may render the virtual event 110 for each spectator 120 in a first-person view format, such that each spectator 120 experiences the virtual event 110 from a unique perspective. For example, the virtual environment 100 may render the virtual event 110 from the first-person perspective on the spectator computing device 130a associated with spectator 120a (e.g., at a first end of a group of spectators). Alternatively, the virtual environment 100 may render the virtual event 110 from a third-person point of view, such that spectators 120 can see the entire field, players, and all spectators 120 at the same time. The virtual environment 100 may receive a selection from each of the spectators 120 as to which view they prefer. The virtual environment 100 may render the virtual event 110 on each spectator 120's computing device from the selected point of view. For example, the virtual event 110 may be rendered from a first-person point of view for one spectator 120 and another spectator 120 may experience the virtual event 110 from a third-person point of view.

The virtual environment 100 may include a payment system for the spectators 120. According to some aspects, a payment system for may allow the spectators 120 to select from tiered participation levels associated with the virtual event 110. The payment system may offer a flexible and personalized experience based on preferences and budget. Spectators 120 may choose from multiple tiers, each offering a different level of access and interaction within the virtual event. For example, a basic tier may provide standard access to the virtual event 110 with a limited viewing experience, while a premium tier may offer enhanced features such as exclusive camera angles, higher-quality video streaming, and access to interactive elements like chat (e.g., in real-time) with other spectators 120 or direct engagement with event hosts. Additionally, higher tiers may include customizable avatars, virtual goods, and the ability to participate in special activities or receive digital collectibles related to the virtual event 110. Payments may be processed through a secure online platform that supports various payment methods, including credit/debit cards, digital wallets, and cryptocurrency. Once payment is completed, an account associated with the spectator 120 may be upgraded to the selected tier, unlocking the corresponding features and benefits for the duration of the virtual event 110.

In some aspects, the virtual environment 100 may include interactive elements that spectators 120 may engage with during the virtual event 110. The interactive elements may include mini-games, polls, or trivia related to the ongoing event, providing an additional layer of engagement for spectators 120. For example, during a virtual soccer game, spectators 120 may be able to predict the outcome of certain plays or vote on in-game decisions, such as which player should take a penalty kick. The interactive elements may be accessed through the spectator computing devices 130 and may be displayed on the same interface as the virtual event 110, allowing seamless participation without disrupting the viewing experience.

According to some aspects, the virtual environment 100 may support social interactions between spectators 120. Moreover, closed groups of spectator avatars 140 may be formed for private interactions. Spectator avatars 140 may engage in communication (e.g., in real-time) with other avatars through text, audio, or video channels integrated into the virtual environment 100. For example, a group of friends attending the same virtual soccer match may form a closed group where they can discuss the game privately, exchange comments, and react to in-game events. The virtual environment 100 may form closed groups based on user-defined criteria such as mutual interests, affiliations, or invitations, to ensure that the social experience is tailored to the preferences of the participants.

Referring now to FIG. 2, illustrated is a networked environment 200, according to one embodiment of the present disclosure. The networked environment 200 may function as the computing infrastructure that manages the virtual environment 100. The networked environment 200 may include spectator computing devices 130. The spectator computing devices 130 may function as an interactive source for rendering games, receiving inputs from the spectators 120, and/or managing any data associated with the spectators 120 and the virtual environment 100. The spectator computing devices 130 may include but are not limited to gaming consoles, cellular devices, tablets, computers, personal laptops, virtual reality systems, and/or any other particular computing device.

The spectator computing devices 130 may each include a central computing system 210. The central computing system 210 may function as the central computing environment of the spectator computing devices 130. For example, the central computing system 210 may process data received from one or more input devices 260, render one or more virtual environments 100, update the virtual environment 100 (e.g., in real-time), determine outcomes of the particular game (e.g., in real-time) based on the inputs received from the input devices 260, and/or perform any other computational requirements of the spectator computing devices 130.

The spectator computing devices 130 may each include a memory 220. The memory 220 can function as a high-speed storage device, a short-term storage device (e.g., Random Access Memory (RAM)), a long-term storage device, and/or any particular combination thereof. The memory 220, for example, may store spectator data, rendering data, event data, organization data, and/or any other data associated with the virtual environment 100. The spectator data may include any data associated with the spectators 120. For example, the spectator data may include but is not limited to spectator profiles, account names, account passwords, financial information, 3-D rendering data, image data, spectator names, and associated events or organizations. The rendering data may include any data associated with rendering the virtual environment 100. For example, the rendering data may include a seat map, a stadium rendering, a field rendering, rendered sports equipment, and one or more avatar renderings. The event data can include any data associated with the particular event being attended in the virtual environment 100. For example, the event data may include but is not limited to scheduling information (e.g., time or date) and/or event rules and calculations for defining interactions for the particular event. The organization data may include any data associated with one or more organizations with which the spectator is affiliated. For example, the organization data may include organization profiles, associated events, associated spectators 120, and/or any other information associated with the organizations. Though discussed in the context of the memory 220, the data stored in the memory 220 can be stored in a memory 220, in an event server 280, and/or in any particular combination of data locations distributed across the network 270.

The spectator computing devices 130 may each include a network communication module 230. The network communication module 230 may function as a data distribution source for the one or more spectator computing devices 130. For example, the network communication module 230 may send data to any location distributed across the network 270. In another example, the network communication module 230 may receive data from any particular location distributed across the network 270. The network communication module 230 may handle transmission and reception of data packets, including one or more the rendering data or updates related to the positions and actions of spectator avatars 140. This data exchange (e.g., delayed or in real-time) may keep all spectators 120 aligned in their viewing experience, regardless of their geographical location or the type of device being used. The network communication module 230 may also support adaptive streaming protocols to adjust the quality of the transmitted data based on the spectator's network conditions, thereby minimizing latency and buffering issues.

The spectator computing devices 130 may each include a user interface 240. The user interface 240 may include a rendered interface that can display the virtual environment 100, interactive pages, account setting pages, account login pages, and/or any particular interface for the spectator computing devices 130. The user interface 240 may update in real-time to display the live action of a particular event. The user interface 240 may vary based on inputs received through the input devices 260. For example, the movements of a particular spectator avatar 140 may change (e.g., in real-time) on the user interface 240 based on inputs received from the input devices 260.

The user interface 240 may include various interactive elements within the virtual environment 100, further enhancing spectator engagement. For example, the user interface 240 may display interactive elements, such as live polls, trivia, and in-game predictions, which spectators 120 can participate in during the virtual event 110. The interactive elements may be rendered on the user interface 240 and may be dynamically updated based on the ongoing events within the virtual arena. For example, during a virtual soccer match, spectators 120 may receive prompts on their devices to predict the outcome of a penalty kick, with the results of the poll being displayed to all participants (e.g., in real-time or upon completion of the poll).

Spectators 120 may interact with the user interface 240 to select and purchase virtual goods, such as clothing, accessories, and digital collectibles, which may then be applied to their respective spectator avatars 140. The user interface 240 may present a virtual marketplace where spectators 120 may browse available items, make purchases using an integrated payment system, and/or see the changes reflected in their avatar's appearance. This customization process may be influenced by real-time events. For example, limited-edition items related to specific events or achievements within the virtual environment 100 may be offered via the user interface 240.

The spectator computing devices 130 may each include an imaging device 250. The imaging device 250 may be a mobile phone camera, a standalone camera, a webcam, or a specialized three-dimensional (3D) scanner. The imaging device 250 may be used to generate a 3D representation of a user's face. The 3D representation of the user's face may be used to generate custom spectator avatars 140 for the spectators 120.

According to some aspects, the imaging device 250 may capture (e.g., in real-time) one or more facial expressions of the user during the virtual event. The captured expressions may be mapped onto the spectator avatar 140, allowing the spectator avatar 140 to reflect emotions or reactions of the spectator (e.g., in real-time). For example, if the spectator 120 smiles, frowns, or displays surprise, the expressions of the spectator 120 may be dynamically illustrated on the face of the spectator avatar 140 within the virtual environment 100. The spectator avatar 140 may resemble the spectator 120 in appearance and/or convey an emotional state of the spectator 120, thereby providing a more personalized and interactive experience for both the user and other participants in the virtual arena.

The spectator computing devices 130 may each include one or more input devices 260. The input devices 260 may generate inputs from the spectators 120. For example, the input devices 260 may include gaming controllers, keyboards, mouses, touch screen displays, virtual reality controllers, microphones, cameras, touchpads, and/or any other particular input device. The input devices 260 may generate inputs that control their respective spectator avatars 140.

The imaging devices 209 may obtain a 3D representation of the face of a spectator 120 by capturing one or multiple images of the face of the spectator 120 from multiple angles. The spectator computing device 130 may stitch the multiple captured images together to generate a 3-dimensional map of the user's face. The stitching process may include identifying facial landmarks of interest in each image, and co-registering the images together based on the relative positions of the landmarks in each image. For example, image processing software resident on the spectator computing device 130 or the event server 280 may identify the location of a user's nose, eyes, eyebrows, and mouth in each image. Image processing software may compute a distance between the identified facial landmarks in each image and combine the measured distances from images captured at different angles to determine a three-dimensional shape of the user's face. The three-dimensional shape may then be used to generate a spectator avatar 140.

In one aspect, the event server 280 generates 3D representations of the faces of spectators 120 based on pre-captured images supplied by the spectator 120. For example, the event server 280 may access one or more locally stored images of the spectator 120's face on the spectator computing device 130. Image processing software resident on the event server 280 may analyze the retrieved images to identify the locations of facial landmarks and generate a 3D representation of the spectator 120's face according to the methods described above. In another example, the event server 280 or the spectator computing device 130 may connect with one or more social media accounts of a particular spectator 120. Continuing this example, the event server 280 and/or the spectator computing device 130 may extract from the social media accounts of the particular spectator 120 one or more facial images. Further continuing this example, the event server 280 and/or the spectator computing device 130 may generate a 3D representation of the face of the particular spectator 120.

The event server 280 may alter an image provided by a spectator 120 according to the preferences of the spectator 120. For example, a spectator 120 may provide an image and select changes to the hair color, facial shape, or other visual feature. The event server 280 may apply image processing algorithms to adjust the desired feature prior to generating a 3D representation of the spectator 120's face.

According to some aspects, the spectator avatar 140 may be created using AI-driven technologies, such as deepfake technology, to produce a realistic and dynamic facial representation. Moreover, spectators 120 may opt to alter their appearance by utilizing AGI (Artificial General Intelligence) technology, which may allow for more advanced and creative modifications beyond their real-world likeness. For example, appearance alterations may include altering facial features, adding stylistic elements, or creating a wholly unique avatar face that reflects their desired persona within the virtual environment. Furthermore, spectators 120 may choose from a selection of preconfigured character options, allowing for quick and easy avatar creation that suits their preferences or the theme of the virtual event. By providing flexibility for spectators 120 to choose the appearance of the spectator avatars 140, spectators 120 may engage in the virtual arena with a spectator avatar 140 that either closely mirrors their real-world appearance or embodies a completely different character of their choosing.

According to some aspects, a different representation of the actual spectator avatars 140 may be presented to other spectators 120 to enhance the overall visual fidelity and performance of the virtual environment. For example, while a spectator avatar 140 may be rendered in real-time with a high degree of customization and detail on their own spectator computing device 130, the representation of that avatar as viewed by other spectators 120 may be adjusted to optimize rendering efficiency or to maintain consistent visual quality across diverse hardware configurations. This alternative representation may involve simplified models, reduced detail levels, and/or stylistic alterations that align with the aesthetic or technical requirements of the virtual event. As another example, the event server 280 may apply advanced rendering techniques or artistic modifications to the spectator avatar 140 when displaying it to others, such as enhancing facial features, adjusting lighting, or adding dynamic expressions that might not be present in the original representation. These modifications may optimize the avatar's appearance for various display devices or to align with the visual style of the virtual event, ensuring a more cohesive and polished presentation. Such adaptations may be especially beneficial in scenarios where device capabilities vary among spectators or where the immersive quality of the event is prioritized, thereby maintaining a consistent and visually appealing experience across the virtual arena.

According to some aspects, the virtual environment 100 may include one or more virtual spectators that are not controlled by other spectators 120. These virtual spectators may be algorithmically generated to enhance the atmosphere of the virtual event, filling in seats, adding background interactions, and/or contributing to the overall sense of a lively and immersive crowd. For example, system-controlled spectator avatars 140 may be programmed to display a range of behaviors and reactions, such as cheering, clapping, and/or engaging in simulated conversations, each of which may be tailored to match the nature of the virtual event. This inclusion of virtual fans may ensure that the virtual arena feels dynamic and populated, even in scenarios where the number of live spectators is limited, thereby maintaining a consistently engaging and authentic experience for all participants.

The event server 280 may generate digital representations of virtual events (e.g., sporting events, concerts, conferences, etc.) and may communicate the digital representations to spectator computing devices 130 via the network 270. The event server 280 may receive spectator information from the spectator computing devices 130. For example, the event server 280 may receive information as to the three-dimensional shape of a user's face. The event server 280 may combine received information from multiple spectators to generate a virtual rendering of a particular event. For example, in a soccer context, the event server 280 may receive spectator information from different spectators corresponding to different positions in the grandstands. The event server 280 may combine the received information to generate individual representations of each spectator 120 in the grandstands. The event server 280 can transmit the generated representations to the spectator computing devices 130 such that each spectator 120 can experience the virtual event. The event server 280 may receive inputs from the spectators 120 to move spectator avatars 140 on the field during the virtual event. The event server 280 may combine inputs from all spectators 120 and update the positions of the spectator avatars 140 in the virtual grandstand according to the received inputs.

The event server 280 may facilitate the formation and management of closed groups within the virtual environment 100. Spectators 120 who wish to have private discussions or interactions during the virtual event 110 may create or join these groups, with access being controlled through user-defined criteria such as invitations or shared interests. The event server 280 may ensure that communication within the closed groups is secure and isolated from the broader virtual audience, thereby allowing for a more personalized and private spectating experience.

According to some aspects, the rendering of the virtual environment 100 may be optimized through a distributed computing architecture, where the workload is split between the event server 280 and the spectator computing devices 130. For example, the event server 280 may manage complex calculations related to the simulation of the virtual event 110 and the synchronization of multiple spectators 120, while the spectator computing devices 130 may handle the rendering of graphics and the user interface. This division of resources and workload my ensure that the system can scale efficiently to accommodate large numbers of spectators 120 without compromising the quality or responsiveness of the virtual experience.

Moreover, the rendering of the virtual event 110 may be dynamically by adjusting the level of detail based on the spectator's device capabilities. The dynamic adjustment may provide spectators 120 with a seamless user experience across a wide range of hardware configurations, e.g., from high-end gaming systems to mobile devices. The event server 280 may monitor the performance of each spectator computing device 120 (e.g., in real-time) and may adjust the graphical fidelity of the rendered environment, accordingly, ensuring that all spectators 120 can enjoy a high-quality experience tailored to their device's performance.

The spectator computing devices 130 may be communicatively coupled to each other and to the event server 280 via a network 270. The network 270 may be a local area network, or the internet. According to various aspects, the virtual environment 100 may split the workload associated with generating and maintaining the virtual environment 100 between the spectator computing devices 130 and the event server 280. For example, the event server 280 may execute processes associated with generating a digital sporting event, keeping track of relevant spectator data, and integrating user inputs across multiple devices (so-called “back-end” processes). The spectator computing devices 130 can execute processes associated with rendering graphical displays to the spectators 120.

One or more security features may be managed by the event server 280 or the spectator computing devices 130. For example, the one or more security features may include end-to-end encryption of all communications within the virtual environment 100. The one or more security features may protect sensitive data such as personal information, payment details, and private interactions within closed groups. The event server 280 may implement redundancy and failover mechanisms to maintain service continuity in the event of hardware or network failures. The redundancy and failover mechanisms may ensure that the virtual event 110 remains accessible to spectators 120 without interruptions, even under adverse conditions.

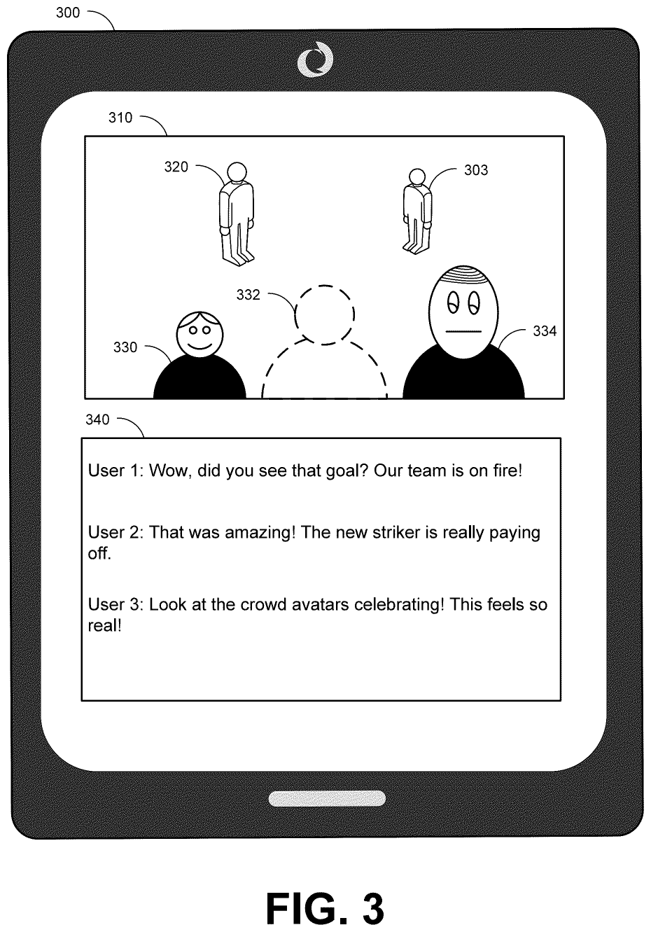

Referring now to FIG. 3, shown is an exemplary user interface 300. The user interface may include a virtual event 310. The virtual event 310 may be characterized by a pre-determined schedule (e.g., a set time and date). Moreover, the virtual event 310 may include one or more virtual players 320. The user interface may further include one or more spectator avatars (e.g., first spectator avatar 330, second spectator avatar 332, or third spectator avatar 334). Each of the spectator avatars may be defined by one or more characteristics (e.g., size, facial features, hairstyle, etc.) chosen by the spectators which they represent. According to some aspects, one or more of the spectator avatars (e.g., first spectator avatar 330, second spectator avatar 332, or third spectator avatar 334) may be virtual fans or spectators that are not controlled by any humans. The user interface may further include a dialogue between 340 between the spectators.

The exemplary user interface 300 may provide a dynamic and immersive environment for spectators engaging with a virtual event 310. The virtual event 310 may include one or more virtual players 320, which may be representations of real or fictional characters participating in the event. The virtual players 320 may be depicted engaging in activities such as a sports match, concert, or another interactive event, providing a central focus for the spectators.

The user interface 300 may include one or more spectator avatars, such as the first spectator avatar 330, the second spectator avatar 332, and the third spectator avatar 334. The spectator avatars may be customizable, allowing spectators to select characteristics such as size, facial features, hairstyle, and clothing, which may reflect their personal preferences or real-world appearance. This customization may enhance a connection between the spectators and their digital representations, fostering a more engaging and personalized experience within the virtual event 310.

In addition to visual elements, the user interface 300 may facilitate communication among spectators through a dialogue section 340. This dialogue section 340 may enable spectators to exchange messages, either text-based or via audio/video channels, enhancing the social aspect of the virtual event 310. Spectators may discuss ongoing activities, share reactions, or strategize in games, thereby replicating the social interactions typically found in physical events. The user interface 300 may also include other UI elements, such as interactive buttons, pop-up notifications, or contextual menus, providing additional layers of engagement and interaction. Spectators may initiate interactions themselves or receive prompts from the server, allowing for a dynamic and responsive user experience. Moreover, audio within the virtual environment may be proximity-based, meaning that the volume and clarity of sounds, such as conversations or event-related noises, may increase as a spectator avatar 140 moves closer to another spectator avatar 140 or a specific aspect of the virtual event, and decrease as the avatar moves further away, thereby enhancing the realism and immersion of the virtual event.

Moreover, the user interface 300 may include interactive elements that spectators can engage with during the virtual event 310. The interactive elements may include live polls, trivia questions, or mini games related to the event, offering additional layers of interaction and engagement. For example, during a virtual soccer match, spectators may be prompted to predict the outcome of a penalty kick, with the results being displayed to all participants in real time. The interactive features may be dynamically updated based on the progress of the virtual event, ensuring that the experience remains engaging and relevant.

Additionally, the user interface 300 may support the purchase of virtual goods, which spectators may use to enhance their avatars or participate in exclusive activities within the virtual event 310. These goods may be displayed in a virtual marketplace accessible via the user interface 300, allowing spectators to browse, select, and purchase items that can be immediately applied to their avatars or utilized within the event.

The user interface 300 may provide a seamless and immersive experience that integrates visual, social, and interactive elements, ensuring that spectators remain engaged and invested in the virtual event 310. The flexibility of the user interface 300, which can be accessed across various devices including mobile phones, personal computers, gaming consoles, and augmented or virtual reality systems, may allow for a broad and inclusive audience to participate in the virtual experience.

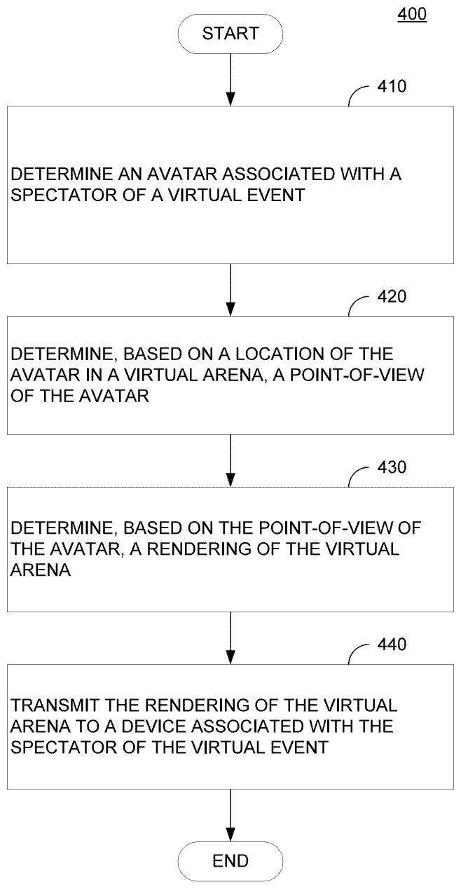

Referring now to FIG. 4, illustrated is a flowchart of a process 400 for rendering and delivering an immersive virtual arena experience to spectators, according to an aspect of the disclosed systems and processes.

At step 410, the process 400 may include determining an avatar associated with a spectator of a virtual event. Existing avatar data associated with the spectator may be retrieved from a user profile. According to some aspects, the creation of a new avatar may be initiated based on input provided by the spectator. The spectator may be prompted to customize various aspects of the avatar to ensure it accurately reflects their preferences and desired appearance within the virtual environment. Customization options may include selecting physical attributes such as facial features, body type, and hairstyle, which may be personalized using a set of predefined options and/or generated through imaging techniques, such as 3D scanning of the spectator's face. For example, images captured by the spectator's device may be analyzed for creation of a three-dimensional digital representation that closely resembles the spectator.

In addition to physical characteristics, the spectator may customize the avatar's clothing and accessories. A virtual wardrobe featuring various items may be presented, such as casual wear, sports jerseys, or formal attire, depending on the nature of the virtual event. Accessories such as hats, glasses, jewelry, piercings, or tattoos may also be available for selection, further enhancing the avatar's uniqueness. The customizations may be influenced by the spectator's preferences, which may be derived from prior selections, profile data, or choices made during the avatar creation process.

Spectators may purchase or unlock additional customization options, such as exclusive outfits or themed accessories, through an integrated virtual marketplace. Once the customization is complete, a final avatar may be generated and associated with the spectator, ready to be rendered and placed within the virtual arena as part of the immersive event experience. The avatar may serve as a digital proxy for the spectator and may enhance the spectator's engagement by providing a personalized representation that can interact with the virtual environment and other avatars.

The virtual event may be set to occur at a specific time and date. According to some aspects, before entering the virtual stadium, spectator avatars may congregate and interact in a shared space, such as a virtual stadium lobby, offering a social experience akin to virtual tailgating. For example, in this shared space, spectators may chat with one another, form groups, and/or discuss the upcoming event, creating a sense of community and anticipation. Additionally, the virtual stadium lobby may provide opportunities for spectators to purchase physical goods and/or digital goods. For example, spectators may order food, such as pizza delivery, or purchase team jerseys that are delivered to their physical location. Moreover, spectators may acquire digital goods, such as new hairstyles or exclusive accessories, to further customize their avatars. Beyond shopping, the virtual stadium lobby may offer unique experiences, such as test-driving the latest electric car model in a simulated environment that replicates the virtual streets surrounding the stadium, adding an additional layer of engagement and entertainment before the event begins.

Moreover, spectators may personalize their avatars using a wide range of digital assets, such as branded clothing, accessories, and virtual goods, which may be acquired through in-app purchases or as rewards for participation in virtual events. The customizations may include dynamic elements that respond to in-game events or spectator interactions, such as animated reactions, special effects, or thematic changes triggered by certain conditions within the virtual arena. For example, during a music concert, clothing associated with an avatar may change to reflect the colors of the performing band, or during a sports event, the avatar may include team jerseys corresponding to a team associated with the spectator.

According to some aspects, the virtual arena experience may be enhanced by integrating real-world events and digital goods. For example, spectators may have the opportunity to purchase virtual replicas of real-world items, such as sports jerseys or concert merchandise, which may be used to customize their avatars within the virtual arena. The digital goods may be tied to real-world purchases, where acquiring a physical product may unlock corresponding virtual items within the virtual arena. Furthermore, interactive features may be supported that allow spectators to experience events from within the virtual arena, such as watching a live concert or sports game in a digital replica of the venue.

At step 420, the process 400 may include determining a POV of the arena (e.g., based on a location of the avatar in the virtual arena). The location of the avatar in the virtual arena may be determined based on various inputs, including pre-defined seating arrangements, spectator preferences, or navigation by the spectator. For example, if the spectator has purchased a specific “seat” within the virtual stadium, the avatar may be initially placed in the corresponding location within the virtual arena. Moreover, the spectator may manually navigate the avatar to different areas within the arena using input devices such as a keyboard, game controller, or VR headset.

The POV may be calculated by determining the visual perspective from the position associated with the avatar. The POV may include the angle, orientation, and field of vision that the avatar would have if it were physically present in the virtual arena. For example, if the avatar is seated in the front row, the POV may focus directly on the event taking place, providing a close-up, unobstructed view of the action. Conversely, if the avatar is positioned in a higher, more distant section of the arena, the POV may provide a broader, panoramic view of the entire event.

As the location of the avatar within the virtual arena changes, either by the navigation of the spectator or by automated system adjustments (such as following the action within a sporting event), the POV may dynamically update to reflect the new position of the avatar. This adjustment may ensure that the experience of the spectator remains consistent with the perspective of the avatar. For instance, if the avatar moves from one section of the virtual arena to another section of the virtual arena, the POV may be recalculated to provide the appropriate visual context from the new location, e.g., by altering the angle, zoom level, and visible elements accordingly.

Interactive elements within the virtual arena that may affect the location of the avatar as well as the POV of the avatar. For example, if the spectator chooses to join a specific activity, such as a mini-game or a group discussion within the arena, the location of the avatar may be automatically adjusted to bring the avatar closer to the relevant area, thereby changing the POV to focus on that activity. The dynamic changes may enhance the immersive experience by ensuring that the view of the spectator is aligned with the position of the avatar and interactions within the virtual environment.

According to some aspects, the POV may be dynamically adjusted as the location of the avatar changes within the virtual arena, allowing the spectator to experience the event from various angles and distances. According to some other aspects, the POV may be fixed, providing a consistent perspective from a predetermined viewpoint, such as a specific seat within the stadium. Furthermore, it is possible for the same virtual seat to be sold multiple times, enabling different spectators to share an identical POV. In some aspects, all spectators may be provided with the same POV, ensuring a uniform viewing experience where each avatar perceives the event from the same perspective, regardless of their individual seating selections.

At step 430, the process 400 may include determining, based on the POV of the avatar, a rendering of the virtual arena. This involves generating a visual representation of the virtual environment as it would appear from the avatar's determined POV. The rendering may include various elements of the virtual arena, such as the event taking place, other avatars, and interactive objects. The rendering process may take into account the capabilities of the spectator's device to ensure an optimal balance between visual fidelity and performance.

At step 430 of process 400, a rendering of the virtual arena may be determined based on the POV of the avatar. The rendering may include creating a visual representation of the virtual arena as it would be seen from the avatar's specific position and orientation within the environment. The rendering may provide the spectator with an immersive and interactive experience, as it translates the POV of the avatar into a visual output that the spectator perceives through their device.

The rendering may be determined based on several factors, including a location of the avatar location within the virtual arena, the angle of view, distance from key elements within the arena, lighting conditions, or any obstacles or other avatars in the line of sight. For instance, if the avatar is positioned near the center of the arena with a direct view of the event, the rendering may focus on close-up details such as the actions of virtual players, textures of the field, and surrounding spectators. In contrast, if the avatar is located in a more distant section of the arena, the rendering may encompass a wider view, capturing the broader scene while potentially reducing the detail level of distant objects to optimize performance.

According to some aspects, spectators may engage with other avatars through various communication channels, including text, voice, or video, which may be integrated into the virtual environment. The interactions may be public, allowing engagement with all participants in the arena, or private, or may occur within closed groups or chat rooms. The social aspect of the virtual experience may be further enhanced by features that allow spectators to share reactions, participate in polls, or collaborate in mini-games directly within the arena. Moreover, spectators may have the opportunity to participate in interactive elements such as live polls, trivia questions, or predictions related to the ongoing event. These elements may be displayed on the user interface (e.g., in real-time), allowing spectators to engage with the event and other participants without interrupting the viewing experience.

The virtual arena may also support interactive activities that mimic real-world experiences, such as virtual tailgating before sports events or virtual meet-and-greet sessions with performers. The activities may be facilitated through specialized zones within the virtual arena, where spectators may gather, socialize, and engage in themed activities. For example, a virtual sports bar within the arena may allow spectators to discuss the game, place virtual bets, or watch replays together, further enhancing the sense of community and immersion.

As the POV of the avatar changes (e.g., through movement within the arena, interaction with the environment, or automatic adjustments) the rendering may dynamically update to reflect the new perspective. For example, visual elements that should be visible from the new angle and distance may be recalculated to keep the view of the spectator consistent with the experience of the avatar. For example, if the avatar turns to face a different direction or moves closer to a particular feature within the arena, the rendering may adjust to show the new angle, bringing different elements into focus while others move out of the field of view.

According to some aspects, the rendering process may incorporate environmental changes, such as dynamic lighting, shadows, and reflections, which may adjust as the avatar moves or as the virtual event progresses. The environmental changes may ensure that the rendering remains realistic and responsive, enhancing the immersion of the spectator in the virtual arena. Additionally, the rendering may be optimized based on the capabilities of the spectator's device, e.g., dynamically adjusting the level of detail, frame rate, and resolution to provide a seamless experience regardless of hardware limitations. The optimization may ensure that the rendering is accurate to the POV of the avatar, while being efficient and tailored to the viewing conditions of the spectator. Moreover, the rendering of the virtual arena may incorporate synchronization mechanisms to maintain consistency across all spectators' views, regardless of their geographical location or device type. Advanced compression algorithms and adaptive streaming protocols may adjust the quality of the visual output (e.g., in real-time), based on network bandwidth and latency. For instance, during high-traffic events, the transmission of critical visual elements and interactions may be prioritized, while dynamically scaling back on non-essential details to preserve the overall quality of the experience.

According to some aspects, rendering techniques may include edge computing and distributed computing architectures to maintain an immersive and consistent experience across diverse hardware configurations. For example, intensive rendering tasks may be offloaded to servers closer to the location of the spectator, thereby reducing latency and improving responsiveness. The rendering engine may dynamically adjust the level of detail, frame rate, and resolution based on the spectator's device capabilities and current network conditions, ensuring that the visual experience remains seamless even under varying technical constraints.

Finally, at step 440, the process 400 may include transmitting the rendering of the virtual arena to a device associated with the spectator of the virtual event. This step involves sending the generated visual content to the spectator's device (e.g., in real-time), enabling the spectator to view and interact with the virtual event as it unfolds. The transmission may utilize advanced compression and streaming techniques to maintain high quality and responsiveness, ensuring a seamless and immersive experience for the spectator.

At step 440 of process 400, the rendering of the virtual arena may be transmitted to a device associated with the spectator of the virtual event. For example, the rendered visual representation of the arena may be converted into a plurality of data packets and may be delivered over a network to a device associated with the spectator. The transmission process is designed to be efficient and responsive, ensuring that the spectator receives an accurate and up-to-date view of the virtual arena as their avatar experiences it.

The rendered image or sequence of images may be encoded into a format suitable for transmission. Depending on the capabilities of the device associated with the spectator and/or network conditions, compression algorithms may be applied to reduce the size of the data packets without significantly compromising visual quality. This compression may minimize bandwidth usage and reduce latency for spectators accessing the virtual event on mobile devices or in areas with limited network capacity.

Once the rendering is encoded, a network communication module may manage the transfer of data. The transmission may occur over various types of networks, including local area networks (LAN), wide area networks (WAN), or the internet, depending on a location of the spectator and infrastructure of the event. Adaptive streaming protocols may adjust quality of the transmission (e.g., in real-time) based on network conditions, ensuring a smooth and uninterrupted experience even if the network performance fluctuates.

As the data packets reach the device associated with the spectator, the data packets may be decoded and rendered on a display of the device, providing the spectator with a live view of the virtual arena from the POV of the avatar. The transmission process may be continuous. Updates may be sent at high frequency to reflect any changes in the position of the avatar, POV of the avatar, or interactions of the avatar within the virtual environment. The updates may ensure that the experience of the spectator may remain synchronized with the movements of the avatar and the ongoing events within the arena.

Additionally, error correction protocols may manage any data loss or transmission errors that occur during the transfer. The error protection protocols may maintain the integrity of the visual rendering and prevent disruptions in the experience of the spectator. The transmission may be buffered in cases where the network connection is temporarily lost or weakened. For example, a small amount of data may be stored on the device associated with the spectator to bridge a gap in transmission and provide a seamless experience until the connection stabilizes.

Resources may be automatically scaled based on the number of spectators and the complexity of the virtual event. The scalability may involve dynamically allocating server resources to handle increased demand during peak times, such as major events with high attendance. Machine learning algorithms may be utilized to predict and pre-load areas of the virtual arena that the avatar is likely to visit, reducing loading times and enhancing the overall experience. By efficiently managing resources, large-scale virtual events with thousands of spectators may be supported, where each spectator receives a personalized and immersive experience tailored to their preferences and device capabilities.

According to some aspects, security protocols may be implemented to maintain a safe and secure environment for spectators. For example, security protocols may include end-to-end encryption of all communications within the virtual arena. The security protocols may protect sensitive data, such as personal information, payment details, and private interactions within closed groups, ensuring that the virtual experience is both secure and private.

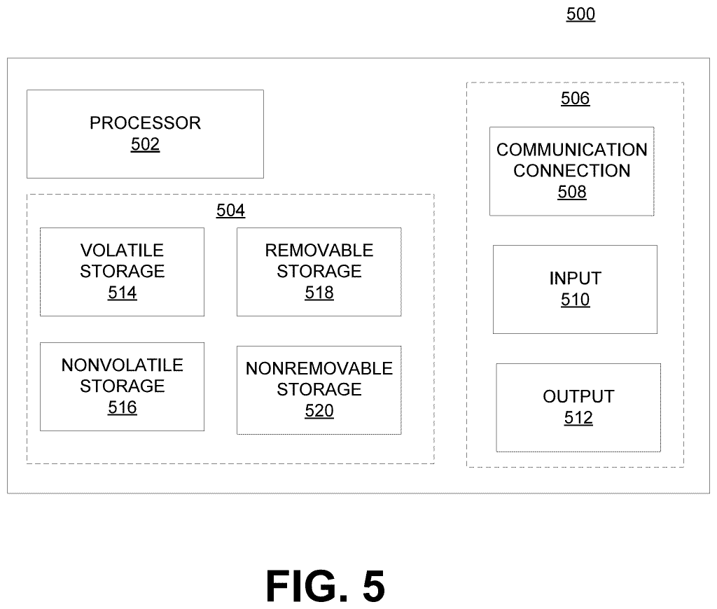

FIG. 5 is a block diagram of a computing device 500 that may be connected to or comprise a component of networked environment 200. Computing device 500 may comprise hardware or a combination of hardware and software. The functionality to facilitate a computing infrastructure that manages the virtual environment 100 may reside in one or a combination of computing devices 500. Computing device 500 depicted in FIG. 5 may represent or perform functionality of an appropriate computing device 500, or a combination of computing devices 500, such as, for example, a component or various components of a spectator computing device 120, central computing system 210, imaging device 250, input devices 260, event server 280, a computing device, a processor, a server, a gateway, a database, a firewall, a router, a switch, a modem, an encryption tool, a virtual private network (VPN), or the like, or any appropriate combination thereof. It is emphasized that the block diagram depicted in FIG. 5 is an example and is not intended to imply a limitation to a specific example or configuration. Thus, computing device 500 may be implemented in a single device or multiple devices (e.g., single server or multiple servers, single gateway or multiple gateways, single controller, or multiple controllers). Multiple network entities may be distributed or centrally located. Multiple network entities may communicate wirelessly, via hard wire, or any appropriate combination thereof.

Embodiments of the computing device 500 may comprise a processor 502 and a memory 504 coupled to processor 502. The memory 504 may contain executable instructions that, when executed by the processor 502, may cause the processor 502 to effectuate operations associated with managing or providing a virtual environment. As evident from the description herein, the computing device 500 is not to be construed as software per se.

In addition to a processor 502 and memory 504, a computing device 500 may include an input/output system 506. The processor 502, memory 504, and input/output system 506 may be coupled together (coupling not shown in FIG. 5) to allow communications between them. Each portion of the computing device 500 may comprise circuitry for performing functions associated with each respective portion. Thus, each portion may comprise hardware, or a combination of hardware and software. Accordingly, each portion of a computing device 500 is not to be construed as software per se. An input/output system 506 may be capable of receiving or providing information from or to a communications device or other network entities configured for adverse media screening. For example, the input/output system 506 may include a wireless communication (e.g., 3G/4G/5G/GPS) card. The input/output system 506 may be capable of receiving or sending video information, audio information, control information, image information, data, or any combination thereof. Input/output system 506 may be capable of transferring information with the computing device 500. In various configurations, the input/output system 506 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, the input/output system 506 may comprise a Wi-Fi finder, a two-way GPS chipset or equivalent, or the like, or a combination thereof.

Embodiments of the input/output system 506 of a computing device 500 also may contain a communication connection 508 that allows the computing device 500 to communicate with other devices, network entities, or the like. The communication connection 508 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. The input/output system 506 also may include an input device 510 such as keyboard, mouse, pen, voice input device, or touch input device. The input/output system 506 may also include an output device 512, such as a display, speakers, or a printer.

Embodiments of the processor 502 may be capable of performing functions associated with providing virtual experiences, such as functions for providing and delivering real-time, immersive, and/or interactive virtual event spectating experiences, as described herein. For example, a processor 502 may be capable of, in conjunction with any other portion of the computing device 500, providing spectators with a seamless and engaging experience across different hardware and network conditions, as described herein.

Embodiments of a memory 504 of the computing device 500 may comprise a storage medium having a concrete, tangible, physical structure. As is known, a signal does not have a concrete, tangible, physical structure. The memory 504, as well as any computer-readable storage medium described herein, is not to be construed as a signal. The memory 504, as well as any computer-readable storage medium described herein, is not to be construed as a transient signal. The memory 504, as well as any computer-readable storage medium described herein, is not to be construed as a propagating signal. The memory 504, as well as any computer-readable storage medium described herein, is to be construed as an article of manufacture.

The memory 504 may store any information utilized in conjunction with providing virtual event experiences. Depending upon the exact configuration or type of processor, a memory 504 may include a volatile storage 514 (such as some types of RAM), a nonvolatile storage 516 (such as ROM, flash memory), or a combination thereof. The memory 504 may include additional storage (e.g., a removable storage 518 or a non-removable storage 520) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by a computing device 500. The memory 504 may comprise executable instructions that, when executed by a processor 502, cause the processor 502 to effectuate operations associated with adverse media screening.

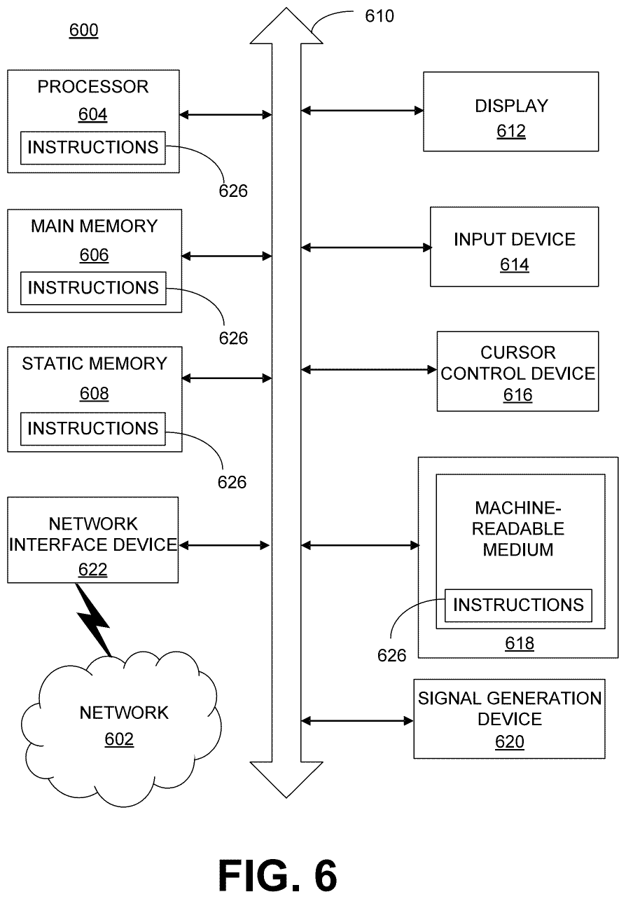

FIG. 6 depicts an example of a diagrammatic representation of a machine in the form of a computer system 600 within which a set of instructions, when executed, may cause the machine to perform any one or more of the methods described above. One or more instances of the machine can operate, for example, as computing device 500, processor 502, spectator computing device 120, central computing system 210, imaging device 250, input devices 260, event server 280, and other devices of FIGS. 1-5. In some examples, the machine may be connected (e.g., using a network 602) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video, or data communication. Further, while a single machine is illustrated, the term “machine” shall also be taken to include any collection of machines that individually or jointly execute a set (or multiple sets) of instructions to perform any one or more of the methods discussed herein.

A computer system 600 may include a processor (or controller) 604 (e.g., a central processing unit (CPU)), a graphics processing unit (GPU, or both), a main memory 606 and a static memory 608, which communicate with each other via a bus 610. The computer system 600 may further include a display unit 612 (e.g., a liquid crystal display (LCD), a flat panel, or a solid-state display). The computer system 600 may include an input device 614 (e.g., a keyboard), a cursor control device 616 (e.g., a mouse), a disk drive unit 618, a signal generation device 620 (e.g., a speaker or remote control) and a network interface device 622. In distributed environments, the examples described in the subject disclosure can be adapted to utilize multiple display units 612 controlled by two or more computer systems 600. In this configuration, presentations described by the subject disclosure may in part be shown in a first of display units 612, while the remaining portion is presented in a second of display units 612.

The disk drive unit 618 may include a tangible computer-readable storage medium on which is stored one or more sets of instructions (e.g., instructions 626) embodying any one or more of the methods or functions described herein, including those methods illustrated above. Instructions 626 may also reside, completely or at least partially, within the main memory 606, the static memory 608, or within the processor 604 during execution thereof by the computer system 600. The main memory 606 and the processor 604 also may constitute tangible computer-readable storage media.

While examples of a system for providing virtual experiences have been described in connection with various computing devices/processors, the underlying concepts may be applied to any computing device, processor, or system capable of facilitating virtual experiences. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer readable storage medium is not a propagating signal. A computer-readable storage medium as described herein is an article of manufacture. When the program code is loaded into and executed by a machine, such as a computer, the machine becomes a device for adverse media screening. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language and may be combined with hardware implementations.

The methods and devices associated with providing virtual experiences as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an erasable programmable read-only memory (EPROM), a gate array, a programmable logic device (PLD), a client computer, or the like, the machine becomes a device for adverse media screening as described herein. When implemented on a general-purpose processor, the program code combines with the processor to provide a unique device that operates to invoke the functionality of an adverse media screening system.

While the disclosed systems have been described in connection with the various examples of the various figures, it is to be understood that other similar implementations may be used, or modifications and additions may be made to the described examples without deviating therefrom. For example, one skilled in the art will recognize that the disclosed systems as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

This written description uses examples to enable any person skilled in the art to practice the claimed subject matter, including making and using any devices or systems and performing any incorporated methods. Other variations of the examples are contemplated herein.

What is claimed:

1. One or more computing devices, comprising one or more processors, configured to:
determine an avatar associated with a spectator of a virtual event;
determine a point-of-view of the avatar;
determine, based on the point-of-view of the avatar, a rendering of the virtual arena; and
transmit the rendering of the virtual arena to a device associated with the spectator of the virtual event.

2. The one or more computing devices of claim 1, wherein the virtual event comprises renderings of player avatars competing in the virtual arena.

3. The one or more computing devices of claim 2, wherein the each of the player avatars is associated with a player participating in the virtual event.

4. The one or more computing devices of claim 1, wherein the virtual arena is a digital representation of a physical stadium.

5. The one or more computing devices of claim 1, wherein the virtual event is selected from the group consisting of a music concert, a sports event, and a comedy show.

6. The one or more computing devices of claim 1, wherein the rendering of the virtual arena comprises one or more interactive elements.

7. The one or more computing devices of claim 1, wherein the rendering comprises a plurality of avatars associated with other spectators in the virtual arena.

8. The one or more computing devices of claim 1, further configured to form a group of a plurality of avatars comprising the avatar, wherein the avatar interacts with another avatar of the group.

9. The one or more computing devices of claim 1, further configured to determine a purchase of a virtual good associated with the avatar.

10. The one or more computing devices of claim 1, further configured to determine, based on one or more characteristics associated with the spectator, an advertisement within the virtual arena.

11. The one or more computing devices of claim 1, wherein the virtual arena comprises a plurality of sections, wherein each section of the plurality of sections is associated with a theme.

12. The one or more computing devices of claim 1, further configured to transmit interactions associated with the avatar to an external platform.

13. The one or more computing devices of claim 1, further configured to receive, from the spectator, a virtual indication of an outcome associated with the virtual event.

14. The one or more computing devices of claim 1, further configured to receive a command associated with controlling the avatar in real-time.

15. The one or more computing devices of claim 1, further configured to optimize the rendering of the virtual arena by dynamically adjusting a level of detail based on one or more capabilities of a device associated with the spectator.

16. The one or more computing devices of claim 1, further configured to determine an area of the virtual event associated with the avatar based on past actions associated with the avatar.

17. The one or more computing devices of claim 1, wherein the rendering of the virtual arena comprises one or more spatial audio characteristics.

18. The one or more computing devices of claim 1, wherein the rendering of the virtual arena is scaled based on a total number of spectators and a complexity associated with the virtual event.

19. A method performed by one or more computing devices, the method comprising:
determining an avatar associated with a spectator of a virtual event;
determining a point-of-view of the avatar;
determining, based on the point-of-view of the avatar, a rendering of the virtual arena; and
transmitting the rendering of the virtual arena to a device associated with the spectator of the virtual event.

20. A system comprising:
one or more processors; and
memory coupled with the one or more processors, the memory storing executable instructions that when executed by the one or more processors cause the one or more processors to effectuate operations comprising:
determining an avatar associated with a spectator of a virtual event;
determining a point-of-view of the avatar;
determining, based on the point-of-view of the avatar, a rendering of the virtual arena; and
transmitting the rendering of the virtual arena to a device associated with the spectator of the virtual event.
